(19) United States
(12) Patent Application Publication
(10) Pub. No.: US 2016/0059503 A1
(43) Pub. Date: Mar. 3, 2016

(54) PLY MAKING APPARATUS FOR TIRE MANUFACTURING

(71) Applicant: THE GOODYEAR TIRE & RUBBER COMPANY, Akron, OH (US)

(72) Inventors: Thierry ROYER, Arlon (BE); Didier WINKIN, Bastogne (BE); Benjamin MONHONVAL, Bellefontaine (BE); Michael DEBRAS, Mersch (BE); Peter Johann Cornelius MAUS, Büllingen (BE)

(21) Appl. No.: 14/791,915

(22) Filed: Jul. 6, 2015

Related U.S. Application Data
(60) Provisional application No. 62/042,959, filed on Aug. 28, 2014.

(51) Int. Cl. B29D 30/34; B29D 30/18

(52) U.S. Cl. CPC B29D 30/34; B29D 30/18; B29D 2030/0033

(57) ABSTRACT

A ply making apparatus for making a tire carcass is described. The ply making apparatus includes a support frame, and a rotatable member mounted to the support frame. The rotatable member further includes a spool mechanism for winding a strip of ply. A first and second bead support holder is located adjacent each other, wherein a first bead support holder supports a first bead in parallel relationship and axial alignment with respect to a second bead held by a second bead holder, wherein the rotatable member is positionable inside each bead.

### FIELD OF THE INVENTION

The invention relates generally tire manufacturing, and, more specifically, to an apparatus for making a tire carcass.

### BACKGROUND OF THE INVENTION

A tire carcass is typically made from two or more layers of ply. The tire ply is typically laid onto a tire building drum in the form of a sheet of ply having ends that are spliced together on the drum. A pair of annular beads are set onto each lateral end of the sheet of ply. Tire components are then added, and the tire building machine typically radially expands and axially contracts while using inflatable bladders to turn up the ply ends, resulting in a torus shaped carcass. The ply endings are typically located in the lower sidewall area of the tire, near the bead. The conventional ply construction due to the location of ply endings can result in reduced bead durability. Another disadvantage of conventional tire ply construction is unequal carcass tension which can result in toe lifting of the bead. Thus a new and improved tire design with improved bead durability is desired. An endless tire ply construction is disclosed, that has no ply endings. Because there is no ply ending, the tire has better durability particularly in the bead area. The endless tire ply results in equal carcass tension on both bead sides, resulting in better bead seating.

### SUMMARY OF THE INVENTION

The invention provides in a first aspect a ply making apparatus for making a tire carcass, the ply making apparatus comprising a support frame, a rotatable member mounted to the support frame, wherein the rotatable member further includes a spool mechanism for winding a strip of ply, and a first and second bead support holder located adjacent each other, wherein a first bead support holder supports a first bead in parallel relationship and axial alignment with respect to a second bead held by a second bead holder, wherein the rotatable member is positioned to rotate inside each bead.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Carcass” means the supporting structure of the tire consisting of plies anchored to the bead on one side and running in a radius to the other side and anchoring to the bead. Also called casing. “First stage carcass” means the tire carcass formed in a cylindrical shape.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Lateral” means an axial direction.

“Lateral edges” means a line tangent to the axially outermost tread contact patch or footprint as measured under normal load and tire inflation, the lines being parallel to the equatorial centerplane.

“Radial” and “radially” means in a direction towards or away from the center of the bead.

### BRIEF DESCRIPTION OF THE DRAWINGS

The invention will be described by way of example and with reference to the accompanying drawings in which:

FIG. 1 is a perspective view of a ply winding apparatus and two bead holder mechanisms;

FIG. 2 is a perspective view of a partially formed carcass of the present invention.

FIG. 3 is a perspective view of a formed carcass of the present invention.

FIG. 4 is a perspective view of the ply winding apparatus and bead holder mechanisms during the forming of a carcass.

FIG. 5 is a perspective view of a spool mechanism.

FIG. 6 is a top view of the spool mechanism of FIG. 5.

FIG. 7 is a side cross sectional view of the spool mechanism of FIG. 5, in the direction C-C.

FIG. 8 is a perspective view of the support frame and rotatable member.

FIG. 9 is a top view of the support frame and rotatable member of FIG. 8.

FIG. 10 is a side view of FIG. 9.

FIG. 11 is a side view of a first side of a bead support mechanism.

FIG. 12A is a side view of a second side of the bead support mechanism of FIG. 11, shown with the cover and bead holder mechanisms removed.

FIG. 12B is a top view of FIG. 12A.

FIG. 13A is a side view of FIG. 12A.

FIG. 13B is a close-up view of the circle of FIG. 13A.

FIG. 14A is a perspective view of a bead holder unit.

FIG. 14B is perspective rear view of the bead holder unit of FIG. 14A.

FIG. 14C is a top view of the bead holder unit of FIG. 14A.

FIG. 14D is a side view of the bead holder unit of FIG. 14C.

FIG. 14E is a bottom view of the bead holder unit of FIG. 14C.

FIG. 14F is a section view in the direction of 14F-14F of FIG. 14E.

FIG. 14G is a section view in the direction of 14G-14G of FIG. 14E.

FIG. 15 illustrates a simplified schematic of the ply wrapper apparatus during rotation of the rotatable member.

FIG. 16 illustrates the ply wrapper apparatus of FIG. 15 wherein the rotatable member is advanced.

FIG. 17 is a perspective view of the first stage tire carcass being transported by the bead holder units to a second stage tire machine.

FIG. 18 illustrates the first stage tire carcass being placed on the drum of the second stage tire machine.

FIG. 19 illustrates a schematic of the motion of the ply as it is being wrapped around the beads A, B.

FIG. 20 illustrates the cross-sectional view of the carcass being formed.

FIG. 21A illustrates a perspective view of the rotatable member.

FIG. 21B illustrates a perspective view of the rotatable member shown with the bridge removably mounted to the rotatable member.

### DETAILED DESCRIPTION OF THE INVENTION

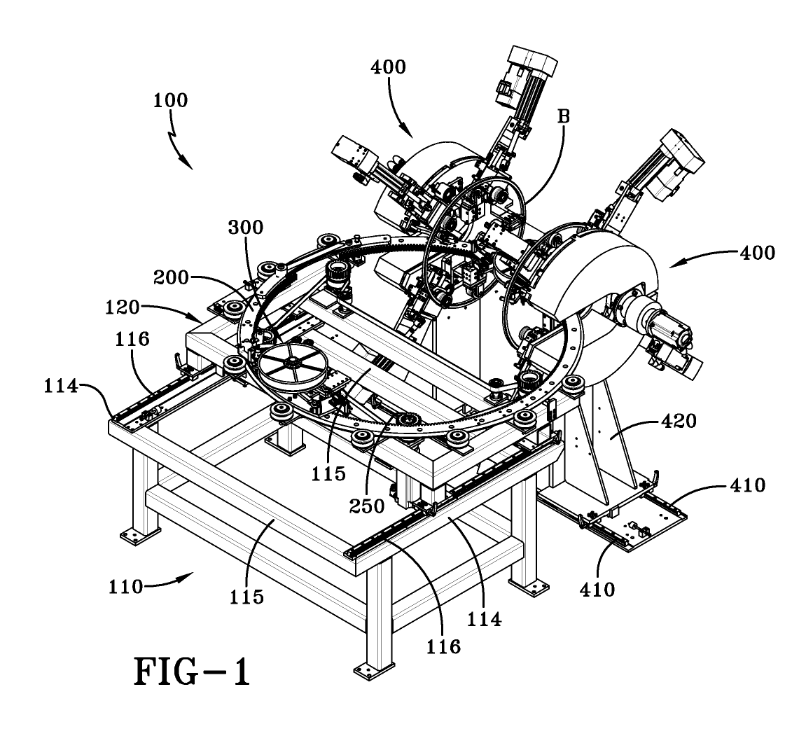

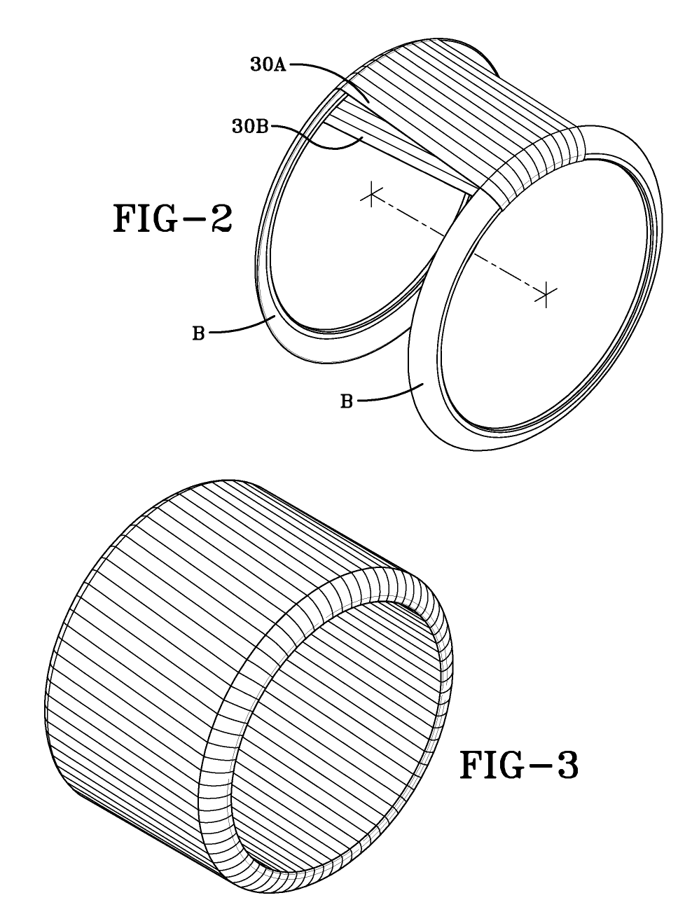

FIG. 1 illustrates a first embodiment of a ply winding apparatus 100 useful for making a tire carcass. A ply strip is wound by the ply winding apparatus 100 around two parallel and spaced apart annular bead cores. The bead core may include an apex attached thereto, so that the ply strip is wound about the bead core and an optional apex. FIG. 2 illustrates the parallel and spaced apart annular beads 101, shown with a narrow strip of ply 102 that has been wrapped around the outer edges of each bead in a continuous manner until at least one layer of ply has been formed as shown in FIG. 3, forming a cylindrically shaped first stage carcass.

### Support Frame

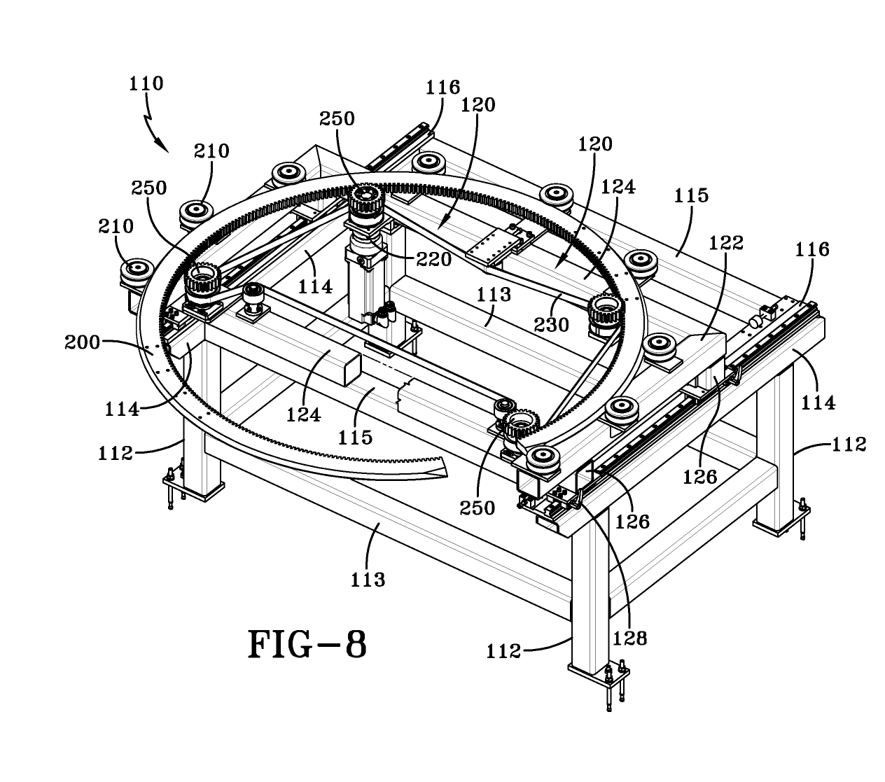

The ply winding apparatus 100 as shown in FIG. 1, includes a rectangular stationary support frame 110. As shown in FIGS. 8-10, the stationary support frame 110 has a plurality of support legs 112 that may be rigidly mounted to the ground. The support legs are joined together by cross-members 113. The upper portion of the stationary support frame has two sets of opposed, parallel rails 114,115 forming a rectangular support. A linear track 116 is mounted on the two opposed parallel rails 114. A slidable support frame 120 is slidably mounted on the two opposed rails 114 of the stationary support frame 110. The slidable support frame 120 is rectangular in shape formed of two sets of opposed, parallel rails 122, 124. Support legs 126 extend from rails 124. The support legs have feet 128 which are configured to slide on linear tracks 116.

### Rotatable Member

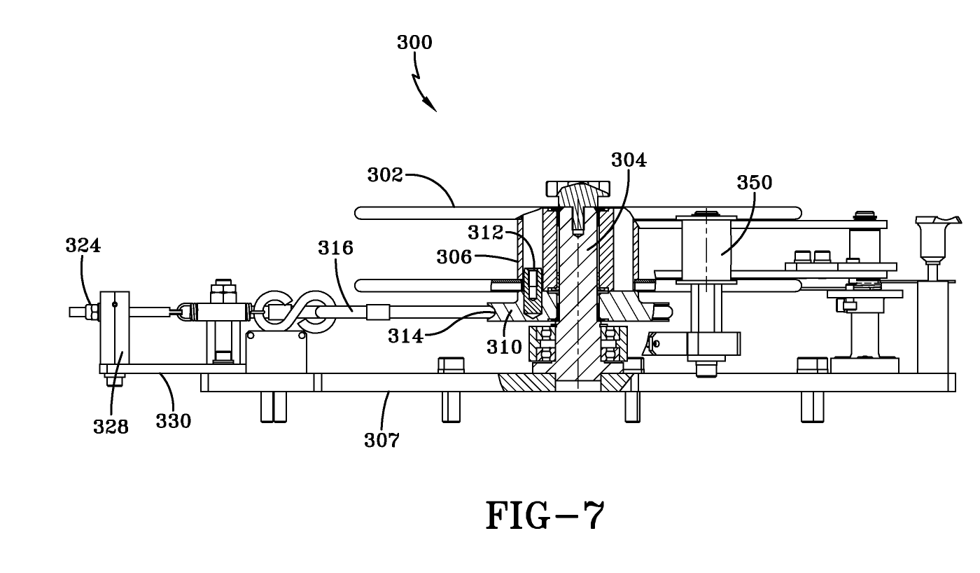

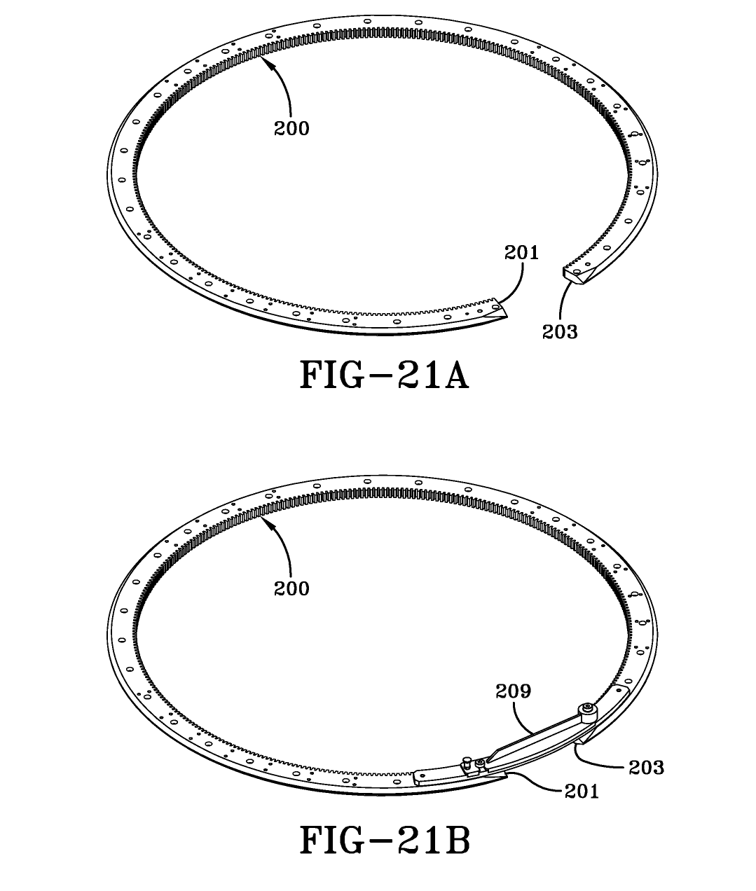

A rotatable member 200 is rotatably mounted to the slidable support frame 120. As shown in FIG. 21A, the rotatable member 200 may comprise a gear mechanism with gear teeth 202 located on the inner periphery 204 or the outer periphery 206. The rotatable member 200 may be a partial circle, of about 340-350 degrees, but preferably less than 360 degrees. Preferably the rotatable member is C shaped. A bridge 209 joins the ends 201,203 together to form an annular member. The bridge 209 is removably mounted to the rotatable member 200. A plurality of guide bearings 210 are located about the rotatable member 200, and are shown in FIG. 7 on the outer periphery of the rotatable member 200. At least one drive mechanism 220 for driving a belt 230 is used to rotate the rotatable member. Belt 230 is mounted about a plurality of gears 250. Rotation of the belt 230 by drive mechanism 220 rotates the rotatable member 200 in a circle of 360 degrees or less.

### Spool Mechanism

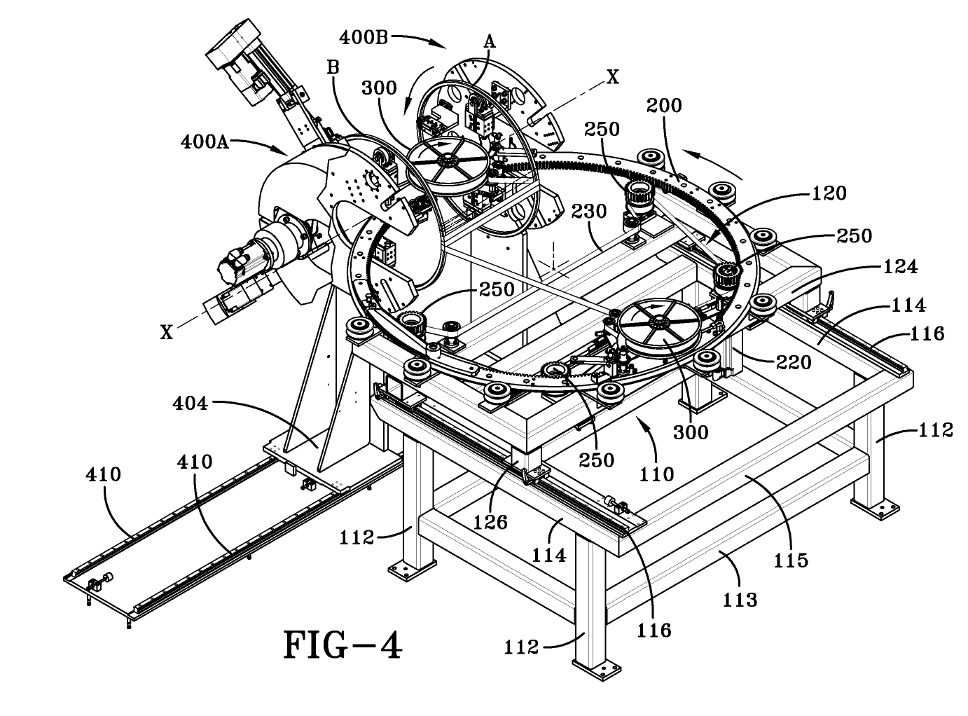

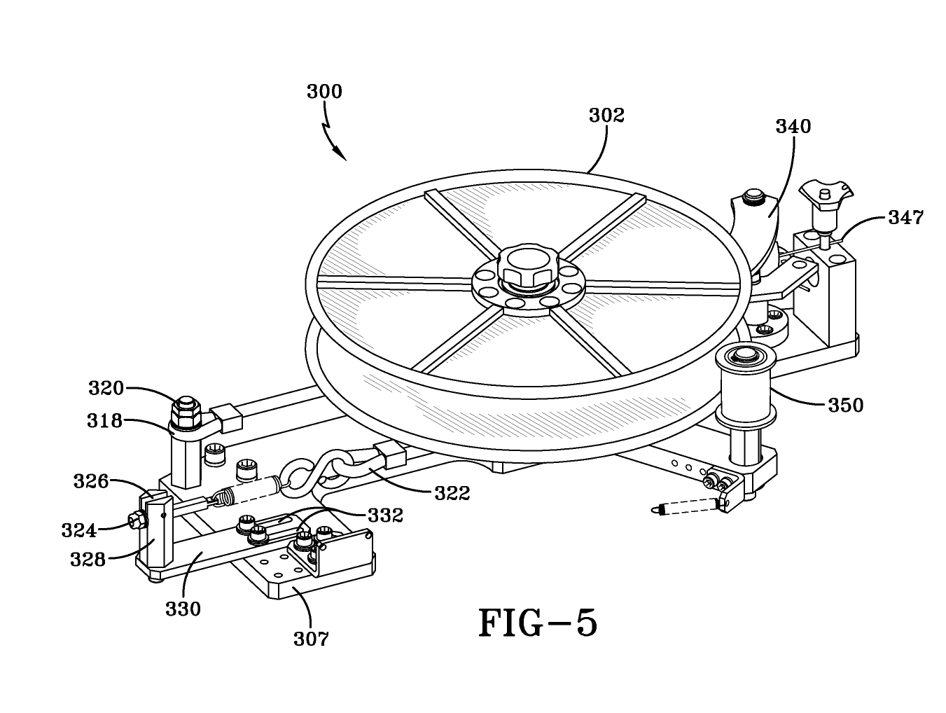

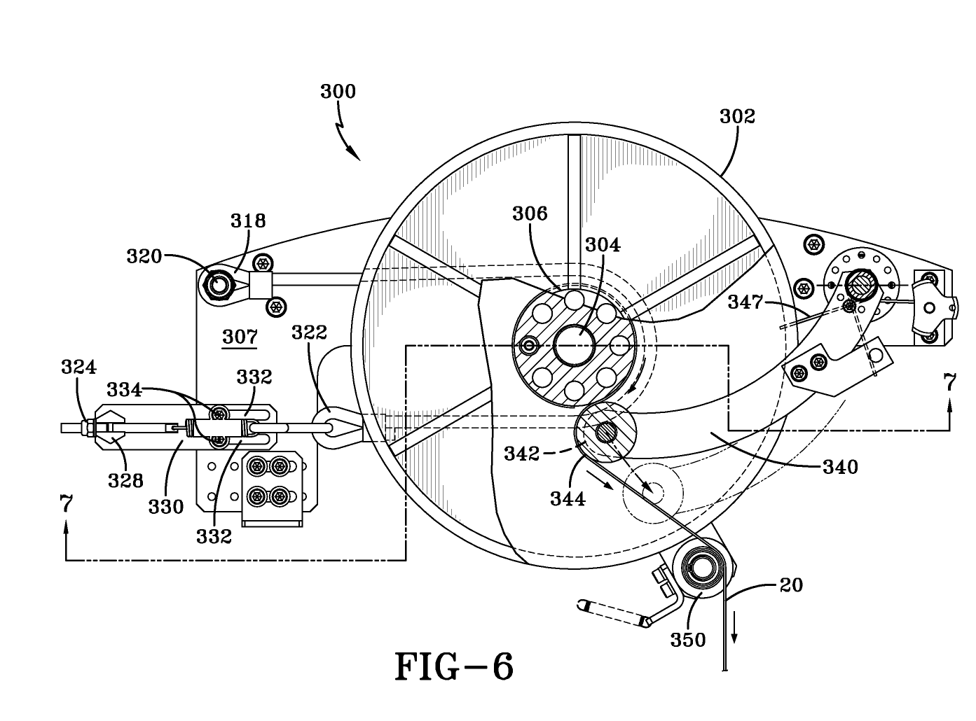

The rotatable member 200 further includes at least one spool mechanism 300 as shown in FIGS. 5-7. The spool mechanism 300 stores a spool 302 of ply strips and includes a mechanism for maintaining the tension of the ply strip. As shown in FIG. 4, two spool mechanisms 300 may be used, and are preferably located opposite from each other. The spool mechanisms 300 each include a spool 302 rotatably mounted about a spindle 304. As shown in FIG. 5, the spindle is mounted to a support plate 307. The spool has an inner hub 306 for winding a strip of ply. The strip of ply is formed of a strip of green rubber having one or more parallel reinforcement cords embedded therein. The cords may be steel, polyester, or other material. The strip is typically about 0.25 inches to about 0.75 inches wide.

As shown in FIG. 7, the inner hub 306 is secured to an annular disk 310 with one or more fasteners 312. The annular disk has an annular groove 314 that has a cable 316 received therein. The cable is wrapped around the annular disk and has a first end 318 secured to the support plate 307 via a fastener 320. The cable has a second end 322 that is secured to the support plate 307 via a fastener 324. The fastener 324 is received in a slot 326 of support member 328. The support member 328 is mounted on an adjustable plate 330. The adjustable plate 330 has two elongated slots 332 for receiving fasteners 334 therein. The adjustable plate position allows the adjustment of the tension of the cable about the annular groove of the annular disk. The higher the cable tension, the less the rotatable spool can rotate. The spool needs to be able to rotate sufficiently to allow the ply strip to unwind in a controlled manner and maintain a tension sufficient to allow the winding of the ply strip around the beads.

The spool mechanism may further include a tension arm 340. The tension arm has a distal end 342 having a roller 344 thereon for engaging the ply stock in the spool. The tension arm maintains tension on the ply strip stock via spring 347 to ensure the ply strip does not unwind from the spool. The spool mechanism further includes a roller guide 350 for guiding the path of the ply strip.

### Bead Support Mechanisms

The apparatus 100 further includes two bead support mechanisms 400. As shown in FIG. 4, each bead support mechanisms 400A, 400B support a bead in parallel relationship a specified distance apart. Each bead support mechanism A,B are structurally the same, except that their mechanical components are reversed with respect to orientation, such that they are mirror images of each other. The bead support mechanism 400A shown in the right hand side of FIG. 4 is as described below. It is to be understood that the bead support mechanism 400B is structurally the same.

### Rotatable Bead Holders

The bead support mechanism 400A includes a base support plate 404. The base support plate 404 has a lower surface 406 with two opposed and parallel support mounts 408 for mounting on opposed, parallel rails 410. The bead support mechanisms 400A, 400B are mounted on the parallel rails, so that the entire bead support mechanism 400A,B can translate laterally along a direction X. A support stand 420 is connected to the base support plate. The support stand 420 may be generally upright or perpendicular to the base support plate.

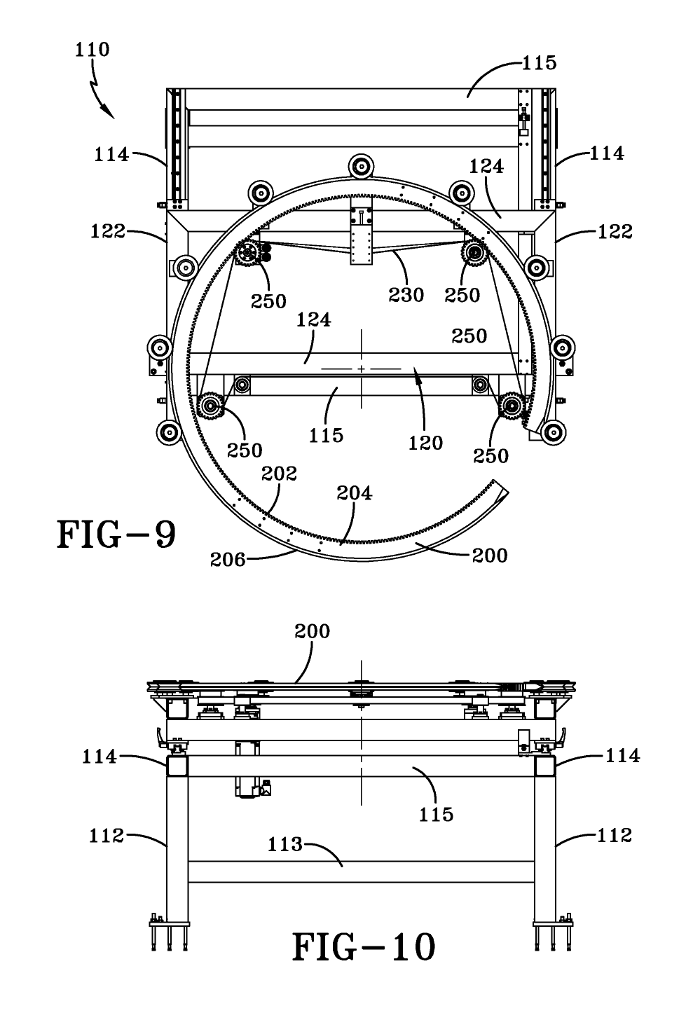

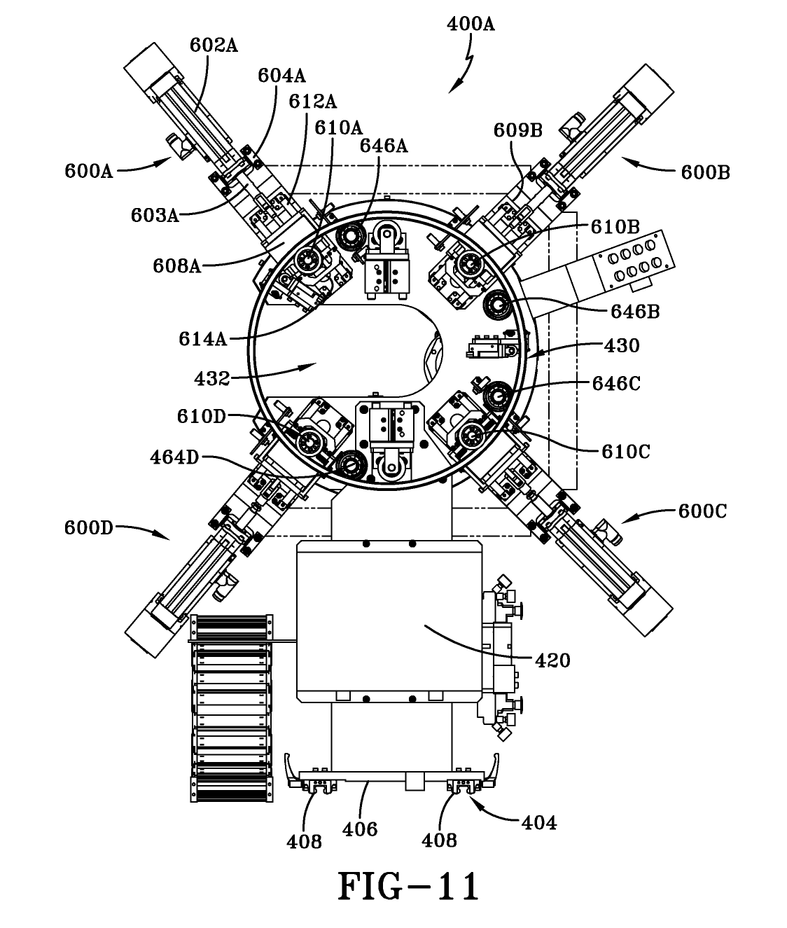

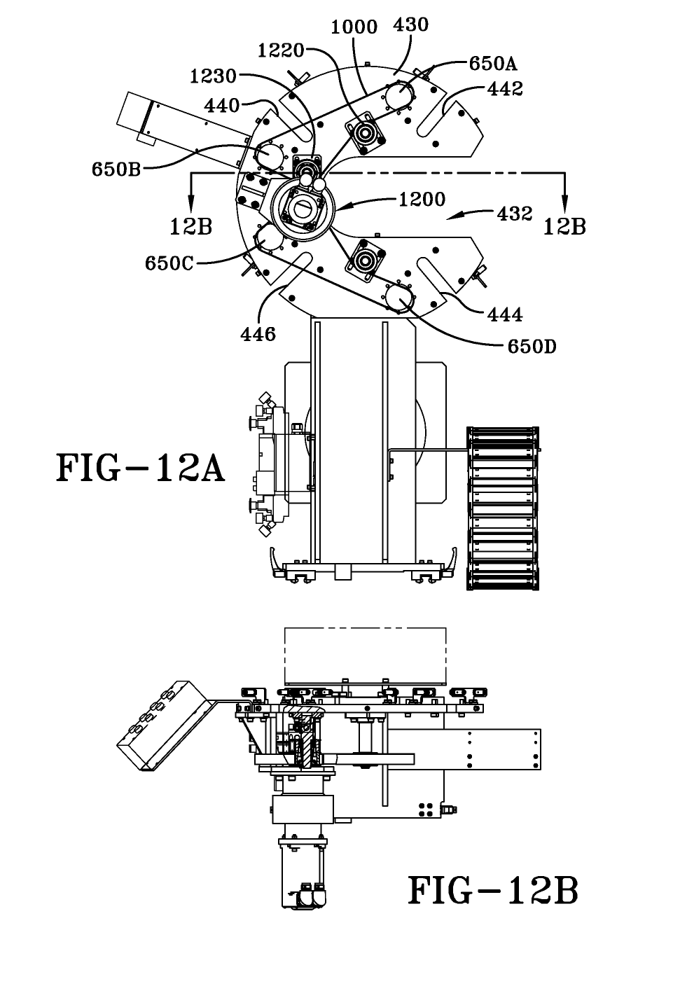

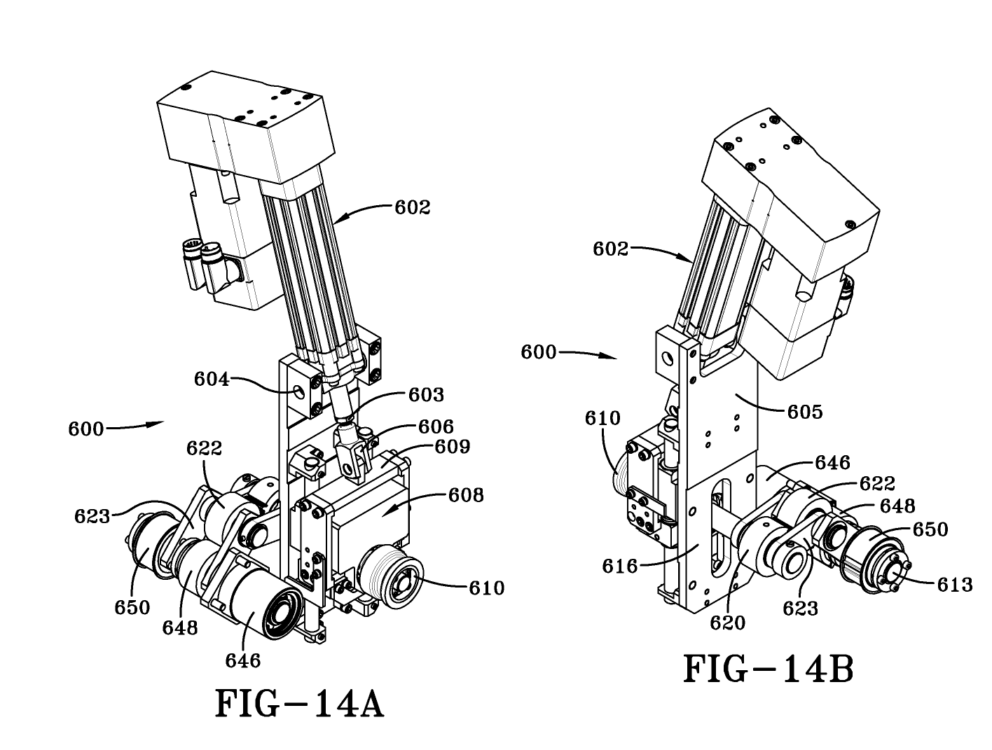

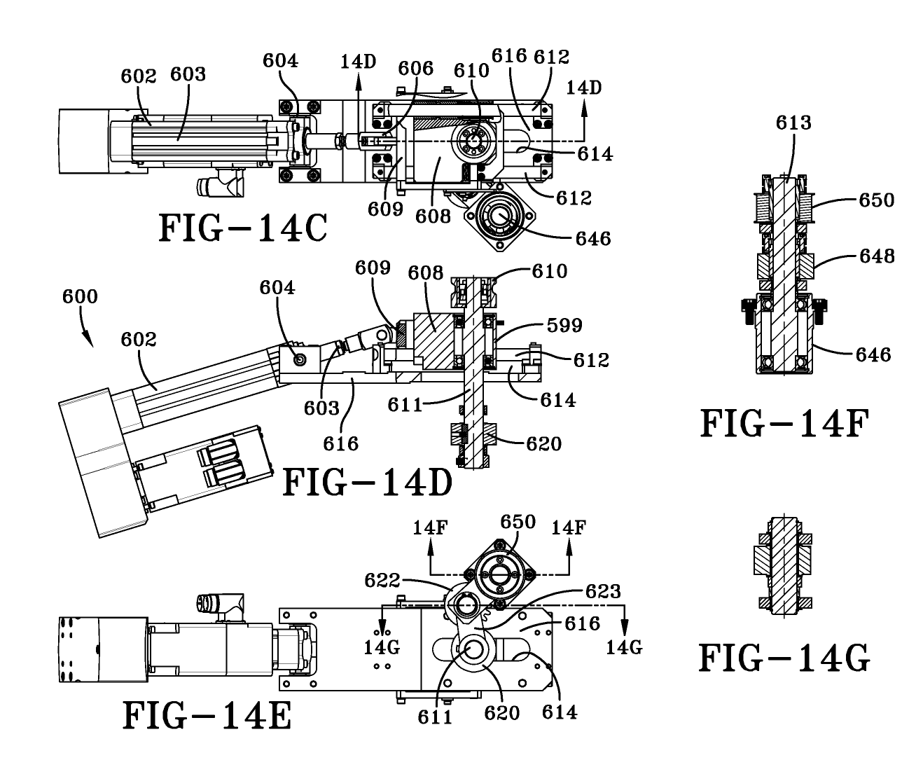

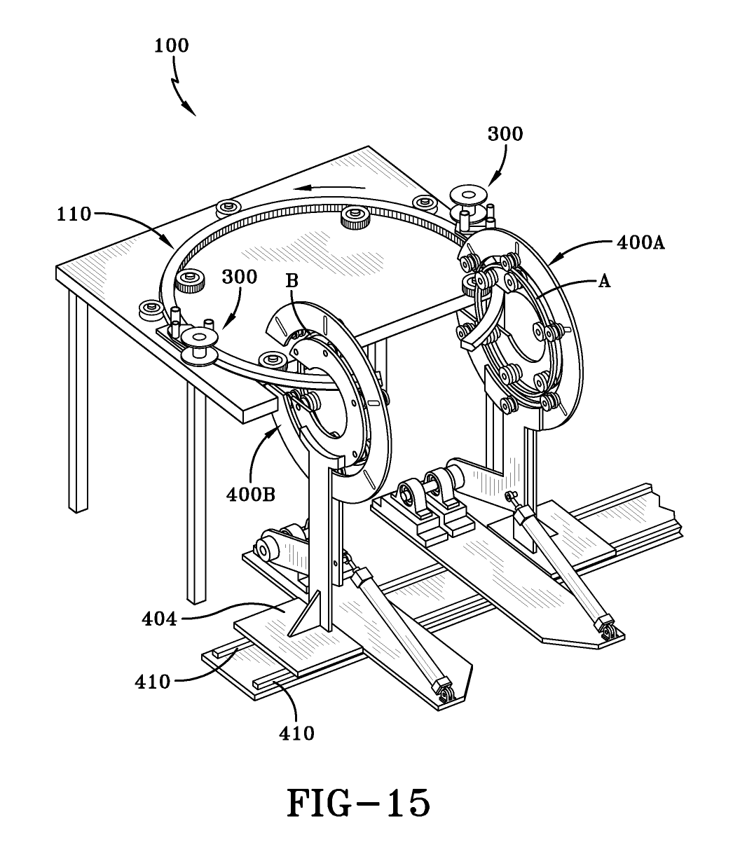

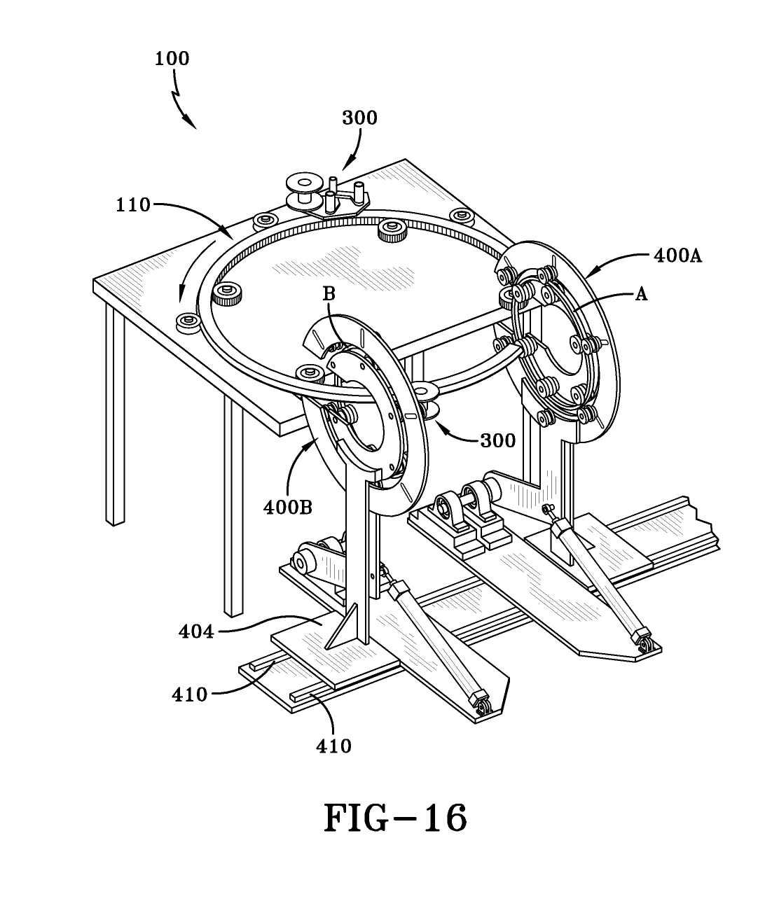

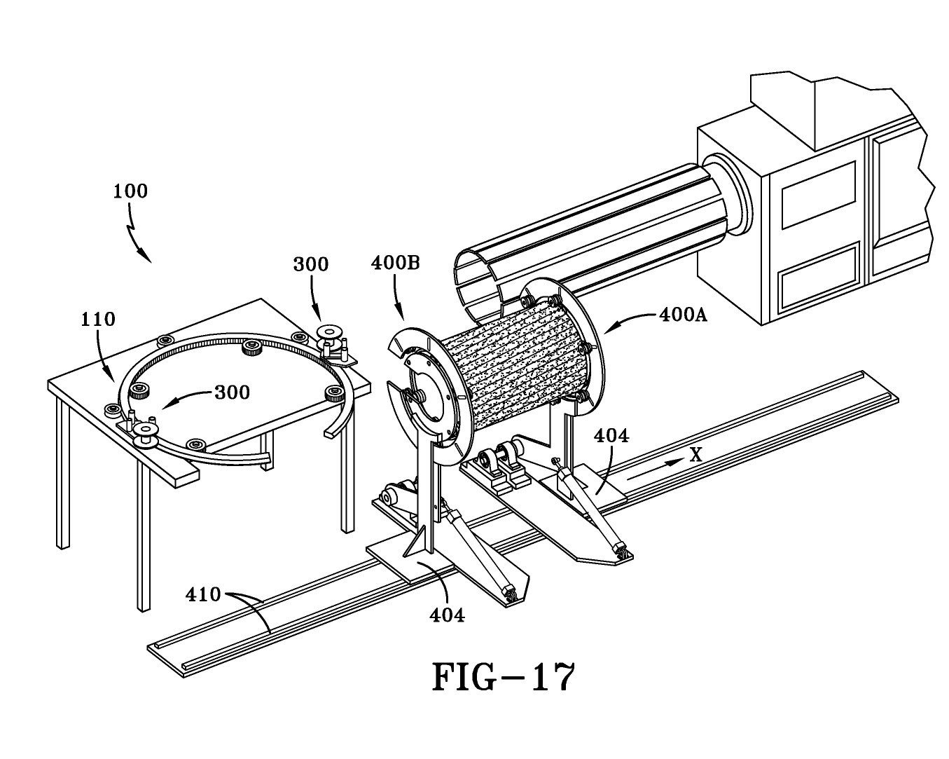

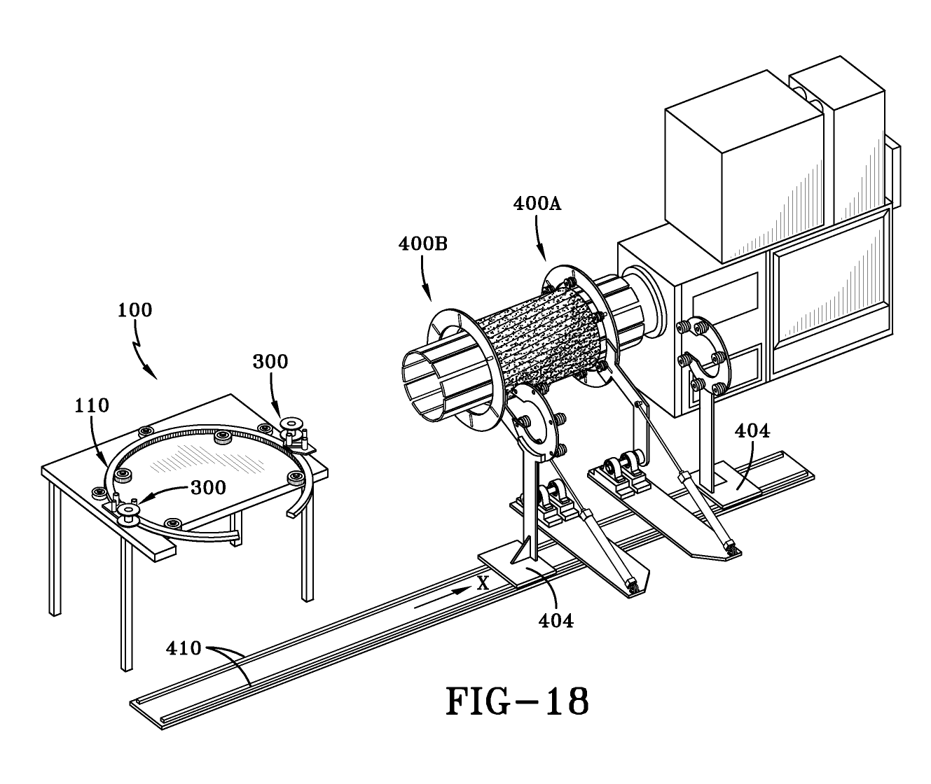

A C shaped member 430 is mounted to the second support plate 420 as shown in FIG. 11. The C shaped member 430 has an opening 432. As shown in FIG. 12A, the C shaped member has at least three, preferably four spaced apart slots 440, 442, 444, 446. The slots 440, 442, 444, 446 receive a bead holder unit 600 therein. Each bead holder unit 600 has a mounting plate 616 which is affixed to the C shaped member 430 with fasteners as shown in FIG. 11. Each mounting plate 616 has an elongated slot 614 which aligns with one of the respective slots 440, 442,444, 446 that the bead holder is mounted in. A slidable shoe 608 is slidably mounted to the mounting plate 616. The lower surface of the slidable shoe 608 is slidably mounted on two opposed, parallel rails 612 for sliding along the longitudinal axis of the slot 616. The front end 609 of the slidable shoe is mounted to a linear actuator 602, which has a slidable piston 603 which is received within pneumatic chamber 602. The first end of the piston 603 is also mounted in stationary guide block 604 which the piston slides therethrough. When the pneumatic actuator is actuated, the piston slides out from its chamber and slides the shoe 608 along the mounting plate in the direction of the longitudinal axis of the slot 614. The slot 614 is oriented so that the slot 614 is aligned in a radial direction towards the centerpoint of the C shaped member. The shoe slides on rails 612. Housed within the shoe is a rotatable shaft 611. The rotatable shaft has a first end having a bead support wheel 610 mounted thereon. The bead support wheel 610 has an outer groove for receiving the bead. As shown in FIG. 14D, the rotatable shaft 611 extends though the slot 614 of the mounting plate and the slot 440 of the C shaped member. The rotatable shaft 611 has a second inner end having a slave wheel 620 mounted thereon. As shown in FIG. 14B, the slave wheel 620 is coupled to an intermediary wheel 622 via a linkage 623. As shown in FIG. 14A, a drive wheel 648 rotates the intermediary wheel 622 which rotates the slave wheel, which rotates the shaft 611 which rotates the bead support wheel 610. The shaft 611 is supported by bearing housing 599. Thus, the shoe slides each bead support wheel into engagement with the annular bead ring, so that the bead is held and rotated by the bead support wheels 610.

### Bead Holder Drive mechanism

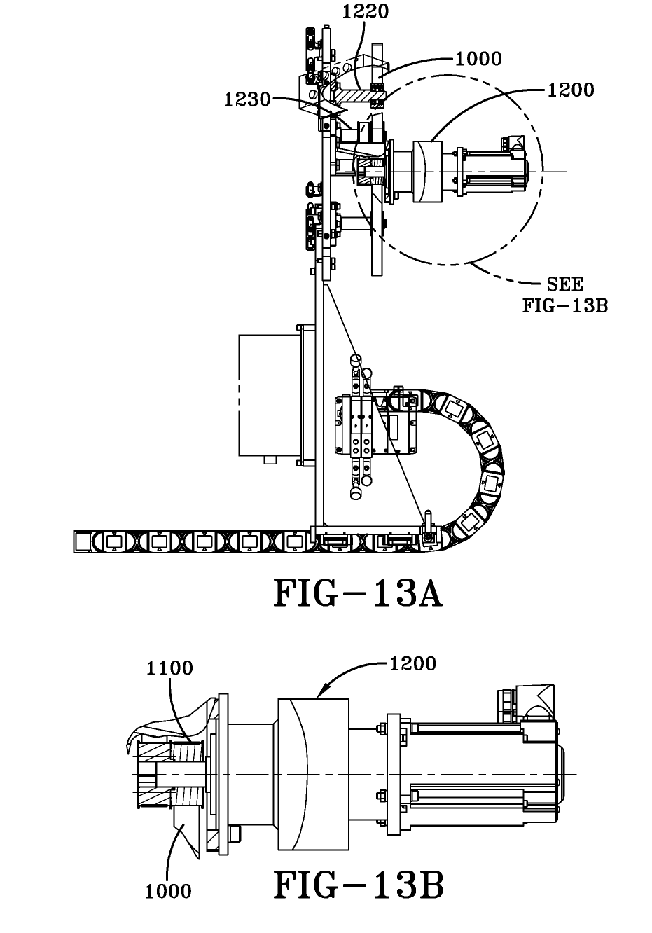

The drive wheel 648 is mounted on a rotatable shaft 613 as shown in FIG. 14F. The drive wheel 648 rotates with shaft 613. A first end of the shaft 613 has a bearing housing 646 which is mounted to the C shaped member as shown in FIG. 11. The shaft has a belt drive wheel 650 mounted on the interior end of the shaft. As shown in FIG. 13A, a belt 1000 is received about the circumference of a first wheel 650A, a second wheel 650B, a third wheel 650C and fourth wheel 650D. Rotation of the first wheel 650A causes the bead support wheel 610A to rotate. The belt 1000 is also received about a second wheel 650B. Between the third wheel and fourth wheel, the first belt 1000 is received about a belt drive chuck 1100 of an electric motor 1200. The electric motor drives the belt 1000, causing rotation of wheels 650A, 650B, 650C and 650D, which in turn causes rotation of wheels 610A, 610B, 610C and 610D, respectively. The belt 1000 is also received about one or more rotatable guide wheels 1220, 1230.

### System operation

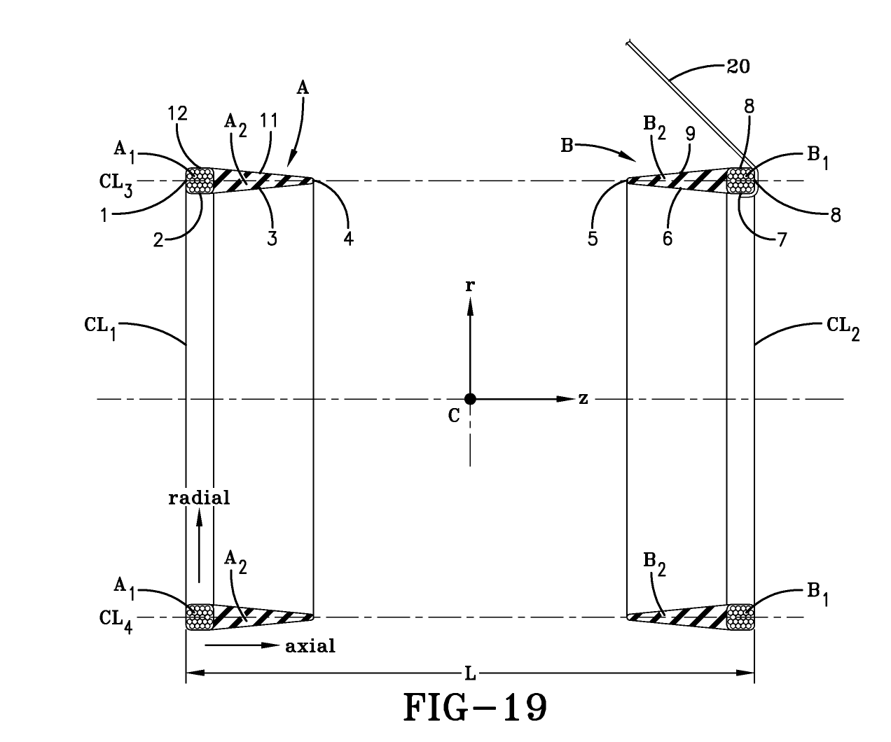

The ply wrapping apparatus of the invention can form a first stage tire carcass as shown in FIGS. 1 through 4. The first stage tire carcass is cylindrical in shape with bead cores A, B located at the ends of the cylinder as shown in FIG. 19. A strip of ply 20 is looped completely around and inside both of the beads forming the tire carcass of FIG. 3. The bead cores are spaced apart an axial distance L, and the bead cores are aligned in parallel relationship to each other. The distance L is determined by the tire designer, and depends upon the specific tire construction characteristics. An optional apex may be joined to the bead core. The apex is typically triangular in shape, and is positioned so that each triangle tip 4,5 is located axially inward of the bead core. The term “bead” used herein means bead core with or without an apex.

In order to form the first stage tire carcass, a first and second bead A,B are each mounted in the bead holder mechanisms 400A, 400B. The bead holder mechanisms are spaced apart so that the beads are spaced an axial distance L from each other. The beads A,B are placed in a parallel relationship to each other, with the centers of each bead in axial alignment with respect to each other. The bead holder's slidable shoe 608 is actuated radially outward to engage and hold a respective bead. Next, the rotatable member 200 is rotated. As the rotatable member 200 is rotated, the spool mechanism 300 is rotated around its axis in a circular fashion. The rotatable member is positioned adjacent each bead core so that the rotatable member passes through or inside each bead during its rotation. With each rotation of the rotatable member 200, the spool mechanism releases a ply strip 20 that wraps around each bead core, wherein each winding extends primarily in the axial direction about each bead A,B forming a first winding or loop. The strips are aligned in an axial direction and parallel with respect to each other with each winding.

As shown in FIG. 19, a cylindrically shaped first stage tire carcass is shown, with two spaced apart beads A, B in parallel relationship to each other. The cylindrical axis or center axis runs through the center of the first stage tire carcass. As used herein, “axial” means in the direction of the longitudinal axis of the first stage tire carcass. “Axially inner” means in an axial direction towards the center C of the carcass, inward of the carcass outer ends C11 and C12, and “Axially outer” means in an axial direction outward of the carcass outer ends.

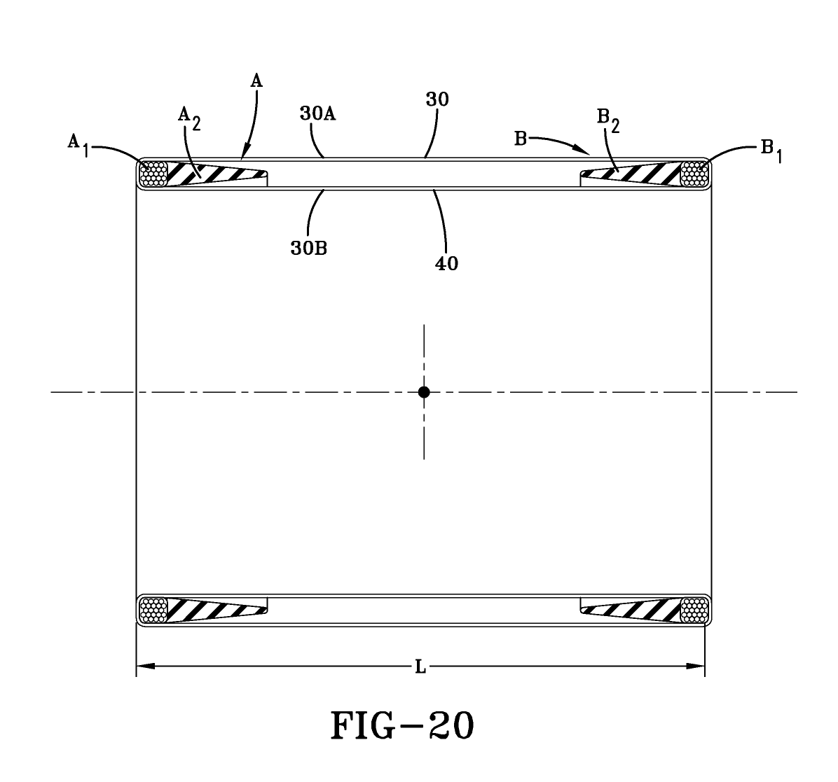

The ply strip winding 30 forms a radially outer portion 30A and a radially inner portion 30B that are spaced apart in parallel relationship. If each bead core A, B includes an apex A2,B2, then the radially outer portion 30A partially or fully engages each bead radially outer surfaces 10,11 of each bead apex A2, B2 as shown in FIG. 20. The radially outer ply winding 30A also engages the axially outer surface 1,8 of each bead core A1,B1. The radially inner ply winding 30B partially or fully engage the radially inner surface 3,6 of each bead apex A2,B2.

If the beads A,B do not include the apexes A2, B2, the ply winding wraps around the axially outer portion of each bead core and the radially outer and radially inner portion of each bead core. The ply winding does not fully wrap around each bead core, omitting the axially inner portion of each bead core.

The ply strip is continuously wound 30, as the bead are rotationally indexed so that the ply strip completely covers both beads, forming a first stage cylindrically shaped carcass as shown in FIG. 3. The ply strips are be wound in such a manner that they are parallel to each other, and extend in an axial direction. The ply strips are wound so that they are radial with respect to the bead. FIG. 2 illustrates that the ply winding results in two layers 30A,30B of ply that are wrapped around the beads and are in parallel relationship to each other. When the carcass is formed into a torus shape during the second stage tire building process, the ply strips will extend in a radial direction from the bead to the tread.

If two spool mechanisms are used as shown in FIG. 4, two windings of ply will occur for each rotation of the rotatable member.

In another embodiment, the rotatable member may be a complete circle, with a portion of the circle being capable of being open or closed.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A ply making apparatus for making a tire carcass, the ply making apparatus comprising:
a. a support frame;
b. a rotatable member mounted to the support frame, wherein the rotatable member further includes a spool mechanism for winding a strip of ply;
c. a first and second bead support holder located adjacent each other, wherein a first bead support holder supports a first bead in parallel relationship and axial alignment with respect to a second bead held by a second bead holder,
d. wherein the rotatable member is positionable inside each bead.

2. The ply making apparatus of claim 1 wherein the rotatable member is C shaped.

3. The ply making apparatus of claim 1 wherein the rotatable member is rotated so that it is inside each bead.

4. The ply making apparatus of claim 1 wherein the rotatable member is rotated so that it is not inside each bead.

5. The ply making apparatus of claim 1 wherein the rotatable member has a removable bridge for bridging the gap of the C shaped member.

6. The ply making apparatus of claim 1 wherein each bead holder rotates its respective bead.

7. The ply making apparatus of claim 1 wherein each bead holder rotates its respective bead in sync with the rotation of the opposite respective bead of the other bead holder.

8. The ply making apparatus of claim 1 wherein the support frame has an upper portion and a lower portion, wherein the upper portion is slidable is a first direction relative to the lower portion.

9. The ply making apparatus of claim 5 wherein the rotatable member is mounted to the upper portion.

10. The ply making apparatus of claim 1 wherein the rotatable member further comprises a second spool mechanism.

11. The ply making apparatus of claim 5 wherein each bead holder is slidably mounted in a second direction, wherein the second direction is transverse to the first direction.

12. The ply making apparatus of claim 1 wherein each bead holder has a c shaped member.

13. The ply making apparatus of claim 9 wherein the c shaped member does not rotate.

14. The ply making apparatus of claim 1 wherein each bead holder has one or more actuators, wherein each actuator is slidable in a radial direction.

15. The ply making apparatus of claim 12 wherein the actuator is a shoe slidable in the radial direction.

16. The ply making apparatus of claim 13 wherein the shoe further includes a rotatable wheel.

17. The ply making apparatus of claim 14 wherein the rotatable wheel is driven by a belt.
